(19) United States
(12) Patent Application Publication
(10) Pub. No.: US 2020/0349315 A1
(43) Pub. Date: Nov. 5, 2020

(54) METHOD AND SYSTEM FOR CONTROLLING LAYOUT OF PAGE ELEMENT FOR VIDEO AND STORAGE MEDIUM

(71) Applicant: BAIDU ONLINE NETWORK TECHNOLOGY (BEIJING) CO., LTD., Beijing (CN)

(72) Inventor: Qun WANG, Beijing (CN)

(73) Assignee: BAIDU ONLINE NETWORK TECHNOLOGY (BEIJING) CO., LTD.

(21) Appl. No.: 16/780,608

(22) Filed: Feb. 3, 2020

(30) Foreign Application Priority Data
Apr. 30, 2019 (CN) 201910358796.0

(51) Int. Cl. G06F 40/106

(52) U.S. Cl. CPC G06F 40/106

(57) ABSTRACT

The present disclosure discloses a method and a system for controlling a layout of a page element for a video and a non-transitory machine-readable storage medium. The method includes: configuring a layout of a page element for a preset time period of the video, the layout of the page element being adaptive to a video content played during the preset time period; and acquiring a current playing time of the video, and displaying the layout of the page element corresponding to the preset time period that matches the current playing time.

### CROSS REFERENCE TO RELATED APPLICATIONS

This application claims priority and benefits to Chinese Application No. 201910358796.0, filed on Apr. 30, 2019, the entire content of which is incorporated herein by reference.

### FIELD

The present disclosure relates to the technical field of video processing, and more particularly, relates to a method and a system for controlling a layout of a page element for a video and a storage medium.

### BACKGROUND

With the development of Internet video technology, video web page, as an important way to carry video contents, may spread contents in a convenient and friendly manner, and thus is a main carrier for users to interact with videos.

### SUMMARY

The present disclosure provides a method for controlling a layout of a page element for a video. The method includes configuring a layout of a page element for a preset time period of the video, the layout of the page element being adaptive to a video content played during the preset time period; and acquiring a current playing time of the video, and displaying the layout of the page element corresponding to the preset time period that matches the current playing time.

The present disclosure further provides a system for controlling a layout of a page element for a video. The system includes a processor and a memory. The memory is configured to store instructions executable by the processor. When the instructions are executed by the processor, the processor is configured to execute the method for controlling a layout of a page element for a video described above.

The present disclosure further provides a machine-readable storage medium, having instructions stored thereon. The instructions are configured to enable a machine to implement the method for controlling a layout of a page element for a video as described above.

Other features and advantages of the present disclosure will be described in detail in the following detailed description.

### BRIEF DESCRIPTION OF THE DRAWINGS

The accompanying drawings constituting a part of the present disclosure are used to provide a further understanding of the present disclosure. The illustrative embodiments of the present disclosure and the description thereof are used to explain the present disclosure, and do not constitute an improper limitation on the present disclosure.

FIG. 1 is a flowchart illustrating a method for controlling a layout of a page element for a video according to embodiments of the present disclosure.

FIG. 2 is a flowchart illustrating a method for controlling a layout of a page element for a video according to embodiments of the present disclosure.

FIG. 3a is a schematic diagram illustrating a positional relationship between a display layer of element components and a video layer according to embodiments of the present disclosure.

FIG. 3b is a schematic structure diagram illustrating an element component A, an element component B or an element component C in the display layer of the element components in FIG. 3a according to embodiments of the present disclosure.

FIG. 4 is a block diagram illustrating a system for controlling a layout of a page element for a video according to embodiments of the present disclosure.

### REFERENCE NUMERALS OF THE ACCOMPANYING DRAWING

1. Video processing module;
2. Page element controller;
3. Display layer of element components;
4. Video layer;
5. Position interface;
6. Style interface.

### DETAILED DESCRIPTION

Hereinafter, specific embodiments of the present disclosure will be described in detail with reference to the accompanying drawings. It should be understood that the specific embodiments described herein are only used to illustrate and explain the present disclosure, and are not intended to limit the present disclosure.

At present, a page element of a video is generally positioned at a fixed position during video playing, and no adjustment is made to the position or style of the page element. In a process of video playing, video content may be blocked by the page element as the video content is often at a lower layer than the page element. In addition, as the color of the page element is same to the color of the video content, the page element cannot be displayed normally. The above problems are very unfriendly to the user experience.

Therefore, the present disclosure provides a method and a system for controlling a layout of a page element for a video and a storage medium, which may automatically adjust the page element based on a playing time, thereby avoiding problems that video content is blocked and a color of the page element is same to that of the video content.

Embodiment of the present disclosure may be described on the basis of obtaining an editing permission of page elements of a video and an ID of the video. For example, before implementing a solution of the present disclosure, the editing permission of the page elements of the video and the ID of the video may be obtained, such that the layout of the page element may be controlled upon obtaining the editing permission of the page elements, and playing time of the video may be obtained upon obtaining the ID of the video. In this manner, the following solutions of the present disclosure may be implemented.

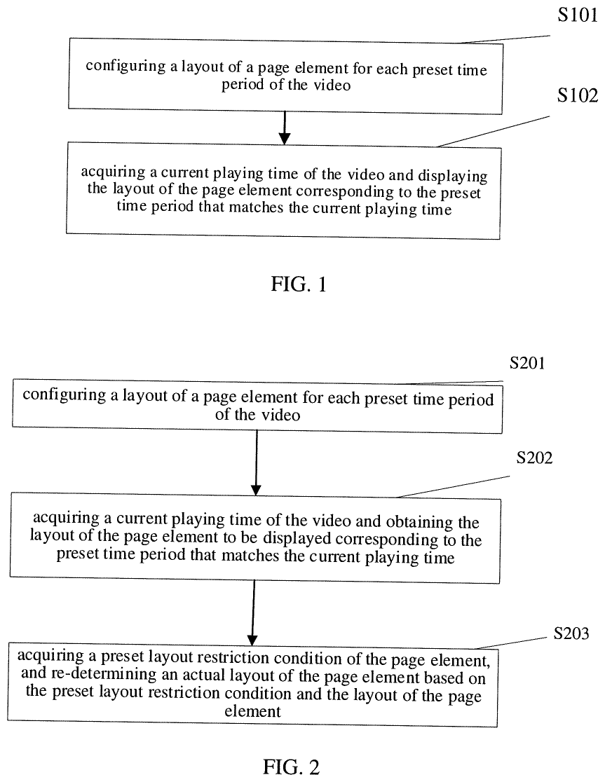

In an embodiment of the present disclosure, as illustrated in FIG. 1, in order to control the layout of the page element, to prevent the page element from blocking the video content and to avoid that the page element has a same color as the video content, a method for controlling a layout of a page element for a video may be proposed. The method for controlling the layout of a page element for a video may include a block S101 and a block S102. At block S101, a layout of a page element is configured for a preset time period of the video. The layout of the page element is adaptive to a video content played during the preset time period. At block S102, a current playing time of the video is acquired, and the layout of the page element for the preset time period that matches the current playing time is displayed.

For example, when a user watches a video, the page element may be displayed on the interface. The page element may include shortcut keys such as “video author” and “follow”. Since the above page elements are arranged at an upper layer of the video, the page element may block the video content due to the display manner, such that the user may be unable to watch the video content. However, the prior art does not concern this problem, and thus the user experience is poor. With the method of the present disclosure, the layout of the page element for the preset time period of the video may be configured in advance. For example, the layout of the page element may be configured such that at a specific time point of the video playing, the “Follow” key may be hidden or compatible with the color of a current page. As another example, the layout of the page element may be configured such that the position of the page element may be changed to prevent the page element from blocking the video at that specific time point. The current playing time of the video is obtained. In a case where the current playing time is the above specific time point, it may be triggered that the page layout may be adjusted according to a preset layout. After the page layout is adjusted, the page element may not block the video content that the user is watching.

Therefore, compared with the prior art, the method for controlling a layout of a page element for a video according to the present disclosure may realize the configuration of the layout of the page element. Consequently, on the basis of the acquired current playing time and the configured layout of the page element, when the user is watching a video, the layout of the page element may be changed with the current playing time of the video, thereby avoiding problems existing in the prior art that the video content may be blocked and the page element may have the same color to the video content.

In an example, the block S101 of configuring the layout of the page element for the preset time period of the video may include: presetting time slice data for each preset time period of the video. The time slice data includes the layout of the page element. The layout of the page element includes changes of the page element, such as addition, deletion, modification and movement of the page element. By determining in real time whether control information exists for the current playing time of the video, the time slice data may be called and used based on the control information. In addition, the time slice data may be stored in a cloud or stored in a preset database to facilitate subsequent use. The format of the time slice data should be uniform and specified according to requirements. In embodiments of the present disclosure, the time slice data may be mainly generated by manually annotating corresponding information offline. The offline manual annotation is to manually store the time slice data, in the format, corresponding to the ID of the video into a data table, thereby facilitating to call the time slice data.

In an example, the block S102 of displaying the layout of the page element for the preset time period that matches the current playing time may include: determining the preset time period that matches the current playing time, and calling the time slice data of the preset time period to display the layout of the page element. After the time slice data is called, the time slice data is finally used to display the layout of the page element. The layout of the page element included in the time slice data may include at least one of: addition of a page element, deletion of the page element and modification of the page element. The modification of the page element may include modifying a style of the page element and modifying a position of the page element. In above examples, modifying the style of the page element may refer to modifying a font color, a font style of the page element, and modifying the position of the page element may refer to modifying the position of the page element with respective to the video page. For example, the page element may be at the top or at the bottom of the video page.

In an example, as illustrated in FIG. 2, the method for controlling a layout of a page element for a video may include a block S201, a block S202 and a block S203. At block S201, the layout of the page element is configured for a preset time period of the video. The layout of the page element may be adaptive to the video content played during the preset time period. At block S202, the current playing time of the video is acquired, and the layout of the page element to be displayed for the preset time period that matches the current playing time is obtained. At block S203, a preset layout restriction condition of the page element is acquired, and an actual layout of the page element is determined based on the preset layout restriction condition and the layout of the page element to be displayed. The layout restriction condition may be configured to define some page elements of which the changes are forbidden. That is, in a case where it is defined that changes of a certain page element are forbidden, even if the current playing time of the video matches the preset time period, the page elements are not changed. For example, it is defined that automatic changes of the font set by the user are forbidden, unless the font is adjusted by the user as necessary. Certainly, this preset method may be set by the user. For example, the font color and the style defined by the user are black and standard typeface of Chinese respectively, which cannot be changed. In this case, with the present disclosure, even if the time slice data is set to change the page element, the page element should maintain the initial style (i.e., black and standard typeface of Chinese), that is, changes are forbidden, unless the user does not set such a limiting condition.

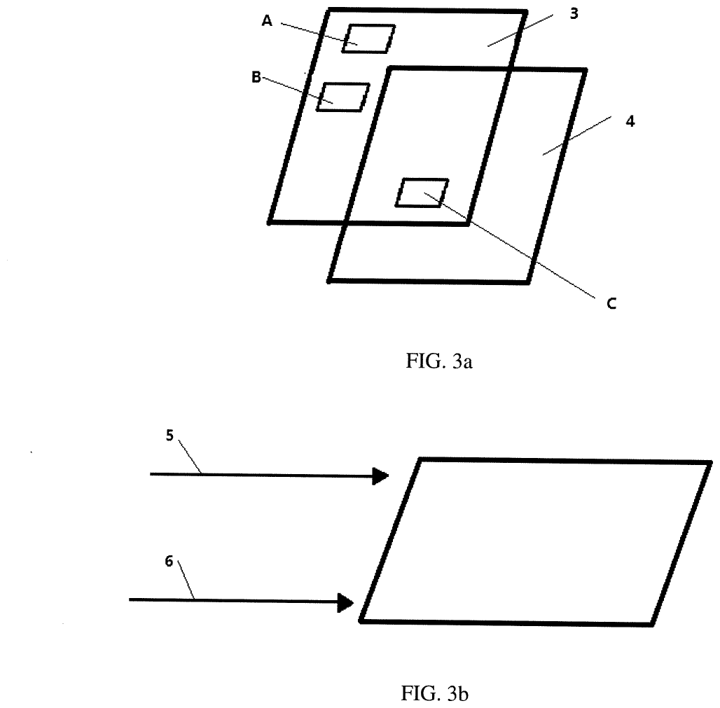

In addition, it should be emphasized that in the present disclosure, the page element may be controlled by a page element control component. In fact, the page element control component may be an execution component for performing position adjustment and color change of the page element. For example, as illustrated in FIG. 3a, a video page is divided into two layers, the lower one being a video layer 4 and the upper one being a display layer 3 of element components. Two external interfaces may be provided at the display layer 3 of the element components, to enable coupling and data transmission of the control information. FIG. 3b illustrates two external interfaces, one being a position interface 5 and the other being a style interface 6. Whether to display or hide the element components and a manner of changing styles such as the color or the shape of the element components are performed based on the control information received by the style interface 6. The position and style of the page elements may be changed based on the received control information.

In an example, as illustrated in FIG. 3a, for example, when the user is watching a video file having a total playing time of 70s, during the time periods of 10 s-20 s, 20 s-50 s, and 50 s-70 s of the video file, problems that the video content is blocked by the page element and the page element has the same color to the video content may occur respectively. The video page may include three element components, i.e., element component A, element component B and element component C. In this case, using the above method of the present disclosure, the time slice data in the video file may be configured in advance, and the video page may be divided in advance into different ranges of coordinates, as described below.
Current time period 1: {
Element component A: {position: {top1, left1}, color: blue),
Element component B: {position: {top2, left2}, color: # fff)};
Current time period 2: {
Element component A: {position: {top3, left3), color: blue),
Element component B: {position: {top4, left4}, color: # fff} };
Current time period 3: {
Element component A: {position: {top3, left3}, color: red},
Element component B: {position: {top4, left4}, color: # fff}
Element component C: {position: {top5, left5), color: # fff}}.

For example, when the current time period 1 is 10 s-20 s, the color of the element component A is changed from the initial color to blue, and the position of the element component A is adjusted from the initial position to the position of {top1, left1}; the color of the element component B is changed from the initial color to a preset color (# fff preset according to actual needs), and the position of the element component B is adjusted from the initial position to the position of {top2, left2}; and since no permission to modify the element component C is acquired, the element component C cannot be modified based on the preset layout restriction condition. When the current time period 2 is 20 s-50 s, the color of the element component A is still blue, and the position of the element component A is adjusted from the position of {top1, left1} to the position of {top3, left3}; the color of the element component B is still the preset color (# fff preset according to actual needs) as described above, and the position of the element component B is adjusted from the position of {top2, left2} to the position of {top4, left4}; and since no permission to modify the element component C is obtained, the element component C cannot be modified based on the preset layout restriction condition. When the current time period 3 is 50 s-70 s, the color of the element component A is changed from blue to red, and the position of the element component A is maintained at the position of {top3, left3}; the color of the element component B is still the preset color (# fff preset according to actual needs) as described above, and the position of the element component B is maintained at the position of {top4, left4}; and the element component C is also adjusted during the time period 3, i.e., the initial color of the element component C is changed into a preset color (# fff preset according to actual needs), and the position of the element component C is adjusted from the initial position to the position of {top5, left5}. With the above embodiments, when the user is watching the video, the position and color of the page element are changed accordingly at 10 s, 20 s and 50 s, so that the user may obtain a good watching experience. In addition, in embodiments of the present disclosure, determining whether the current playing time matches the preset time period may be implemented in following manners. For example, for the interval of 10 s-20 s corresponding to the current time period 1, at the current playing time from 10 s to 12 s, it may be considered that a trigger is obtained, and the position and the color of the page element may be controlled to be changed correspondingly. For the interval of 20 s-50 s corresponding to the current time period 2, at the current playing time from 20 s to 22 s, it may be considered that a trigger is obtained, and the position and the color of the page element may be controlled to be changed correspondingly. For the interval of 50 s-70 s corresponding to the current time period 3, at the current playing time from 50 s to 52 s, it may be considered that a trigger is obtained, and the position and the color of the page element may be controlled to be changed correspondingly. In the present disclosure, the current playing time of the video content may be obtained in real time by using video tags on the webpage, such as a current video resource pointing address of the video, that is, the ID of the video played currently.

In conclusion, in an example, the video webpage may request, based on each video ID, control information of an offline time period of the video from the server through network in advance. After the control information is obtained, the video is divided into multiple time periods. A start of each time period is Key (the value of the Key may be 10 s-12 s in the interval of 10 s-20 s; 20 s-22 s in the interval of 20 s-50 s; and 50 s-52 s in the interval of 50 s-70 s). When the user is watching the video, a page element controller may trigger and call the page element control component in real time, and receive the current video playing time transmitted. In a case where the current playing time is approximate to the value of the Key of the time slice data, the time slice data may be transmitted to the page element control component through the page element controller to guide the change of the style and position of the elements, thereby giving the user different video viewing experiences for different time periods of videos.

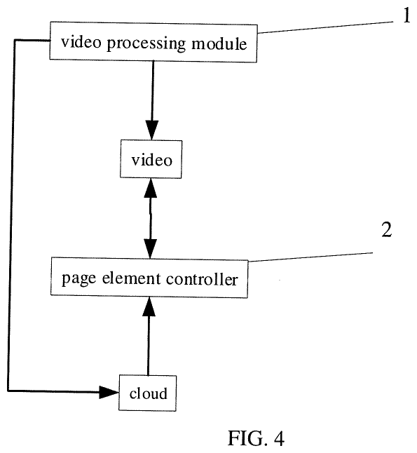

In addition, the present disclosure also provides a system for controlling a layout of a page element for a video. FIG. 4 illustrates a topology of the system for controlling a layout of a page element for a video. The system may include a video processing module 1 and a page element controller 2. The video processing module 1 may be configured to configure a layout of a page element for a preset time period of the video. The layout of the page element is adaptive to video content played during the preset time period. The page element controller 2 may be configured to acquire a current playing time of the video, and to display the layout of the page element corresponding to the preset time period that matches the current playing time.

As described above, the video processing module 1 of the system for controlling a layout of a page element for a video according to the present disclosure may perform data processing on the video in advance by presetting the time slice data for each preset time period of the video. The time slice data includes the layout of the page element. Operations of the video processing module 1 may include manually annotating corresponding information, and storing the corresponding information manually annotated, in a specified format, into a data table corresponding to the video ID as the time slice data. The data table may be stored in the cloud. The time slice data may be called by the page element controller 2.

In an example, the page element controller 2 may be further configured to determine the preset time period that matches the current playing time, and to call the time slice data of the preset time period to display the layout of the page element.

The page element controller 2 may be mainly configured to obtain the time slice data stored, in the format, in the cloud in the video based on the ID of the video. According to the acquired current playing time, a search is performed on the time slice data in real time. In a case where the time slice data of the current playing time includes the control information, the control information called is responded to, and the time slice data is transmitted to the style interface 6 and the position interface 5 (two interfaces as illustrated in FIG. 3b) of the page element control component. After receiving the control information, the page element control component may update the style and position of the page element of the page component based on the time slice data to achieve a desired effect.

In an example, the page element controller 2 may be further configured to acquire a preset layout restriction condition of the page element, and to re-determine the layout of the page element based on the preset layout restriction condition and the layout of the page element. The preset layout restriction condition of the page element may be set in advance, such that some page elements cannot be changed, while some page elements can be changed, which need to be restricted in advance.

For more implementation details and effects of the system for controlling a layout of a page element for a video in the present disclosure, reference may be made to the foregoing embodiments of the method for controlling a layout of a page element for a video, and details will not be repeated herein.

Embodiments of the present disclosure further provide a machine-readable storage medium, having instructions stored thereon. The instructions are configured to enable a machine to implement the method for controlling a layout of a page element for a video according to the above embodiments. When executed on a data processing device, the machine readable storage medium is suitable to execute a program having the following for initialization, which are: configuring the layout of the page element for a preset time period of the video, the layout of the page element being adaptive to the video content played during the preset time period; and acquiring the current playing time of the video, and displaying the layout of the page element corresponding to the preset time period that matches the current playing time. Configuring the layout of the page element for the preset time period of the video may include: presetting time slice data for each preset time period of the video, the time slice data including the layout of the page element. Displaying the layout of the page element corresponding to the preset time period that matches the current playing time may include: determining the preset time period that matches the current playing time, and calling the time slice data of the preset time period to display the layout of the page element. The layout of the page element may include at least one of: addition to the page element, deletion of the page element and modification of the page element. Modification of the page element may include: modifying a style of the page element and modifying a position of the page element. The method for controlling a layout of a page element for a video may further include: acquiring a preset layout restriction condition of the page element, and re-determining an actual layout of the page element based on the preset layout restriction condition and the layout of the page element.

Those skilled in the art will appreciate that embodiments of the present disclosure may be provided as a method, a system, or a computer program product. Accordingly, the present disclosure may take the form of a hardware embodiment, a software embodiment, or an embodiment in combination with software and hardware. Moreover, the present disclosure may take the form of the computer program product that is embodied on one or more computer-usable storage media (including but not limited to disk memories, CD-ROM and optical memories, etc.) including computer-usable program codes.

The present disclosure is described with reference to implementation flowcharts and/or block diagrams of a method, a device (a system) and a computer program product according to embodiments of the present disclosure. It may be understood that each flow and/or block in a flowchart and/or a block diagram, and a combination of a flow and/or a block in a flowchart and/or a block diagram may be implemented by computer program instructions. The computer program instructions may be provided to a processor in a general purpose computer, a special purpose computer, an embedded processor, or other programmable data processing devices to produce a machine, so that instructions executed by a processor in a computer or other programmable data processing devices generate a means configured to implement functions specified in one or more flows in a flowchart and/or one or more blocks in a block diagram.

The computer program instructions may also be stored in a computer readable memory that may instruct a computer or other programmable data processing devices to operate in a particular manner, such that the instructions stored in the computer readable memory produce a manufactured product including an instruction device. The device implements functions specified in one or more flows in a flowchart and/or one or more blocks in a block diagram.

These computer program instructions may also be loaded onto a computer or other programmable data processing devices such that a series of operational steps are performed on a computer or other programmable devices to produce processing implemented by the computer. Consequently, instructions executed on the computer or other programmable devices provide steps for implementing the functions specified in one or more flows in a flowchart and/or one or more blocks in a block diagram.

In a typical configuration, a computing device includes one or more processors (CPUs), input/output interfaces, network interfaces and memories.

The memory may include a non-permanent memory, a random-access memory (RAM), and/or a non-volatile memory in the computer readable media, such as a read-only memory (ROM) or a flash memory (flash RAM). The memory is an example of a computer readable media.

The computer readable media include a permanent, non-permanent, removable and non-removable medium, and the target information may be stored by any method or technology. The target information may be computer readable instructions, data structures, modules of a program, or other data. Examples of the storage medium of the computer include, but are not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage device, a magnetic tape cartridge, a magnetic tape, a magnetic disk storage device or other magnetic storage devices or any other non-transmission media, which can be used to store target information that may be accessed by a computing device. As defined herein, the computer readable media do not include temporary computer-readable media (transitory media) such as modulated data signals and carrier waves.

It should also be noted that the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

Those skilled in the art will appreciate that embodiments of the present disclosure may be provided as a method, a system, or a computer program product. Accordingly, the present disclosure may take the form of a hardware embodiment, a software embodiment, or an embodiment in combination with software and hardware. Moreover, the present disclosure may take the form of the computer program product that is embodied on one or more computer-usable storage media (including but not limited to disk memories, CD-ROM and optical memories, etc.) including computer-usable program codes.

The preferred embodiments of the present disclosure have been described in detail with reference to the accompanying drawings, but the present disclosure is not limited to specific details in the above embodiments. Within the scope of the technical concept of the present disclosure, various simple modifications can be made to the technical solutions of the present disclosure. All of these simple modifications belong to the protection scope of the present disclosure.

In addition, it should be noted that the specific technical features described in the foregoing specific embodiments can be combined in any suitable manner without conflict. In order to avoid unnecessary repetition, various possible combinations are not described separately in the present disclosure.

In addition, an arbitrary combination may be performed on various embodiments of the present disclosure. As long as the combination does not violate the concept of the present disclosure, the combination should also be regarded as a part of the present disclosure.

What is claimed is:

1. A method for controlling a layout of a page element for a video, comprising:
configuring a layout of a page element for a preset time period of the video, wherein the layout of the page element is adaptive to video content played during the preset time period; and
acquiring a current playing time of the video, and displaying the layout of the page element corresponding to the preset time period that matches the current playing time.

2. The method of claim 1, wherein configuring the layout of the page element for the preset time period of the video comprises:
presetting time slice data for the preset time period of the video, wherein the time slice data comprises the layout of the page element.

3. The method of claim 2, wherein displaying the layout of the page element corresponding to the preset time period that matches the current playing time comprises:
determining the preset time period that matches the current playing time, and calling the time slice data of the preset time period to display the layout of the page element.

4. The method of claim 1, wherein the layout of the page element comprises at least one of: addition of the page element, deletion of the page element and modification of the page element;
wherein the modification of the page element comprises: modifying a style of the page element and modifying a position of the page element.

5. The method of claim 1, further comprising:
acquiring a preset layout restriction condition of the page element, and re-determining an actual layout of the page element based on the preset layout restriction condition and the layout of the page element.

6. A system for controlling a layout of a page element for a video, comprising:
a processor, and
a memory, configured to store instructions executable by the processor,
wherein when the instructions are executed by the processor, the processor is configured to:
configure a layout of a page element for a preset time period of the video, wherein the layout of the page element is adaptive to video content played during the preset time period; and
acquire a current playing time of the video, and to display the layout of the page element corresponding to the preset time period that matches the current playing time.

7. The system of claim 6, wherein the processor is further configured to preset time slice data for each preset time period of the video, wherein the time slice data comprises the layout of the page element.

8. The system of claim 7, wherein the processor is further configured to determine the preset time period that matches the current playing time, and to call the time slice data of the preset time period to display the layout of the page element.

9. The system of claim 6, wherein the layout of the page element comprises at least one of: addition of the page element, deletion of the page element and modification of the page element;
wherein the modification of the page element comprises: modifying a style of the page element and modifying a position of the page element.

10. The system of claim 6, wherein the processor is further configured to acquire a preset layout restriction condition of the page element, and to re-determine an actual layout of the page element based on the preset layout restriction condition and the layout of the page element.

11. A non-transitory machine-readable storage medium, having instructions stored thereon, wherein the instructions are configured to enable a machine to implement a method for controlling a layout of a page element for a video, the method comprising:
configuring a layout of a page element for a preset time period of the video, wherein the layout of the page element is adaptive to video content played during the preset time period; and
acquiring a current playing time of the video, and displaying the layout of the page element corresponding to the preset time period that matches the current playing time.

12. The non-transitory machine-readable storage medium of claim 11, wherein configuring the layout of the page element for the preset time period of the video comprises:
presetting time slice data for the preset time period of the video, wherein the time slice data comprises the layout of the page element.

13. The non-transitory machine-readable storage medium of claim 12, wherein displaying the layout of the page element corresponding to the preset time period that matches the current playing time comprises:
determining the preset time period that matches the current playing time, and calling the time slice data of the preset time period to display the layout of the page element.

14. The non-transitory machine-readable storage medium of claim 11, wherein the layout of the page element comprises at least one of: addition of the page element, deletion of the page element and modification of the page element;
wherein the modification of the page element comprises: modifying a style of the page element and modifying a position of the page element.

15. The non-transitory machine-readable storage medium of claim 11, wherein the method further comprises:
acquiring a preset layout restriction condition of the page element, and re-determining an actual layout of the page element based on the preset layout restriction condition and the layout of the page element.
